(19) United States
(12) Patent Application Publication
(10) Pub. No.: US 2005/0210852 A1
(43) Pub. Date: Sep. 29, 2005

(54) Lawn mower blade with detachable cutting edge

(76) Inventor: Wilburn B. Lancaster, Woodland, MS (US)

Correspondence Address: BRADLEY ARANT ROSE & WHITE LLP, 200 CLINTON AVE. WEST, SUITE 900, HUNTSVILLE, AL, 35801, US

(21) Appl. No.: 10/808,702

(22) Filed: Mar. 25, 2004

(51) Int. Cl. A01D 34/73

(52) U.S. Cl. 56/295

(57) ABSTRACT

The present invention provides a lawn mower blade with a detachable cutting edge, an attachment mechanism that connects the cutting edge to the carrier where the attachment mechanism is accessible from the bottom of the carrier and the attachment mechanism is protected from rocks and other foreign objects.

### BACKGROUND OF INVENTION

1. Field of the Invention

The invention relates generally to rotary lawn mower blades.

2. Background Art

Rotary lawn mowers have long since replaced reel mowers as the most common type of mower used in cutting grass and brush. No matter what the size of the mower, the lawn mower blade is typically a long flat, rectangular piece of steel that has been sharpened to a blade on the leading edge of both ends.

Because of wear on the blade, it often needs to be sharpened multiple times a year. The wear depends greatly on the extent of use and also damage caused by foreign objects such as sticks and rocks. Most lawn mower blades are attached to the power shaft of push lawn mowers and the spindle shaft of riding mowers by use of a nut. In order to remove the lawn mower blade to sharpen the cutting edge, it is necessary to prevent the shaft from rotating so that the nut can be taken off. This often proves to be a difficult task. It is especially difficult in larger mowers and so called “riding mowers” as the whole mowing unit needs to be placed on ramps, hoisted or jacked to gain access to the nut holding the mower blade to the drive shaft.

Various types of lawn mower blades have been developed that utilize detachable cutting edges, which can be removed, sharpened and replaced without removing the mower blade. However, a need exists to have a lawn mower blade that has an easily removable cutting edge that also protects the attachment mechanism from damage.

### SUMMARY OF INVENTION

In some aspects the present invention provides a lawn mower blade having a carrier, a detachable cutting edge, an attachment mechanism that connects the cutting edge to the carrier where the attachment mechanism is accessible from the bottom of the carrier.

In other aspects the present invention provides a lawn mower blade having a carrier, a detachable cutting edge, an attachment mechanism that connects the cutting edge to the carrier where the attachment mechanism is accessible from the bottom of the carrier and the cutting edge is shaped to protect the attachment mechanism.

In other aspects the present invention provides a lawn mower blade having a carrier, a detachable cutting edge, an attachment mechanism that connects the cutting edge to the carrier where the attachment mechanism is accessible from the bottom of the carrier and the carrier is shaped to protect the attachment mechanism.

In other aspects the present invention provides a lawn mower blade having a carrier, a detachable cutting edge, an attachment mechanism that connects the cutting edge to the carrier where the attachment mechanism is accessible from the bottom of the carrier and the cutting edge and carrier are both shaped to protect the attachment mechanism.

In other aspects the present invention provides a lawn mower blade having a carrier, a detachable cutting edge, an attachment mechanism that connects the cutting edge to the carrier where the attachment mechanism is accessible from the bottom of the carrier and is above the cutting plane.

In other aspects, the present invention provides a lawn mower blade having a carrier, a detachable cutting edge, an attachment mechanism for attaching the cutting edge to the carrier where the carrier is shaped to protect the attachment mechanism.

In other aspects, the present invention provides a lawn mower blade having a carrier, a detachable cutting edge, an attachment mechanism for attaching the cutting edge to the carrier where the cutting edge is shaped to protect the attachment mechanism.

In other aspects, the present invention provides a lawn mower blade having a carrier, a detachable cutting edge, an attachment mechanism for attaching the cutting edge to the carrier where the blade assembly is shaped to protect the attachment mechanism.

In other aspects, the present invention provides a carrier, a cutting mechanism and a means for mounting a cutting mechanism to the carrier where the means for mounting can be accessed from the bottom of the carrier.

In other aspects, the present invention provides a carrier, a cutting mechanism and a means for mounting a cutting mechanism to the carrier where the means for mounting is protected by the carrier.

In other aspects, the present invention provides a carrier, a cutting mechanism and a means for mounting a cutting mechanism to the carrier where the means for mounting is protected by the cutting mechanism.

In other aspects, the present invention provides a carrier, a detachable cutting edge, an attachment mechanism that connects the cutting edge to the carrier where the attachment mechanism is accessible from the bottom of the carrier and a slot safety mechanism.

Other aspects and advantages of the invention will be apparent from the following description and the appended claims.

### BRIEF DESCRIPTION OF DRAWINGS

FIG. 1a is a perspective view of a carrier and detachable cutting edges.

FIG. 1b is a top view of an individual cutting edge.

FIG. 1c is a side view of an individual cutting edge.

FIG. 1d is a side view of a carrier.

FIG. 1e is a side view of a blade assembly.

FIG. 2a is a top view of a cutting edge with recessed holes for receiving the head of an attachment mechanism.

FIG. 2b is a side view of a cutting edge.

FIG. 2c is a side view of a carrier.

FIG. 2d is a side view of a blade assembly.

FIG. 3a through FIG. 3i present various profile views of differing blade assemblies.

FIG. 4a through FIG. 4i present various profile views of differing blade assemblies.

FIG. 5a presents a top view of end region of a carrier with slot safety mechanism

FIG. 5b presents a side view of a cutting edge with slot safety mechanism.

FIG. 6 is a perspective view of an example carrier.

### DETAILED DESCRIPTION

The following definitions are provided for a consistent understanding of the invention described.

The term “carrier” refers to a plate that is connected to the drive shaft of a push lawn mower engine or the spindle shaft of a riding mower. Generally a carrier is rectangular and metal.

The term “cutting edge” refers to the detachable edge that serves as the cutting mechanism for the “blade assembly”.

The term “attachment mechanism” refers to the mechanism that connects the “cutting edge” to the “carrier.”

The term “blade assembly” refers to the combination of a “carrier”, “cutting edge” and “attachment mechanism.”

The term “cutting plane” refers to the rotational plane of the “blade assembly.”

In the present invention a lawn mower blade with a detachable cutting edge is provided.

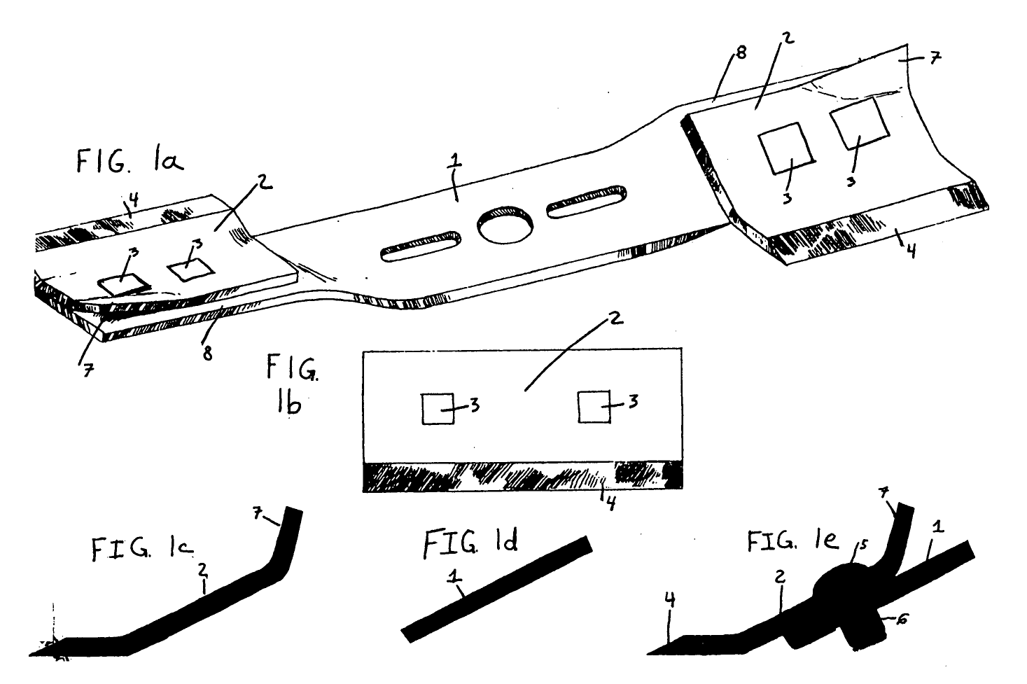

FIG. 1a is a perspective view of one example of a carrier 1 and detachable cutting edges 2. The cutting edges have shaped holes 3 cut through them which correspond with matching holes on the carrier. FIG. 1b is a top view of an individual cutting edge. The leading edge 4 of the cutting edge is sharpened. FIG. 1c is a side view of an individual cutting edge. The back corner 7 of the cutting edge is optionally bent upwards to be compatible with certain types of mulching mowers. FIG. 1d is a side view of the carrier 1. The matching shaped holes 3 in the cutting edges and carrier prevents bolts 5 or other attachment mechanisms from rotating when put though the holes 3 and secured with a nut 6 forming a blade assembly as shown in FIG. 1e. The nut 6 can be accessed from the bottom of the blade assembly for removal. The ends of the carrier 8 are twisted to an angle. This prevents rocks and other foreign objects from impacting directly on the attachment mechanism as the assembly rotates in operation.

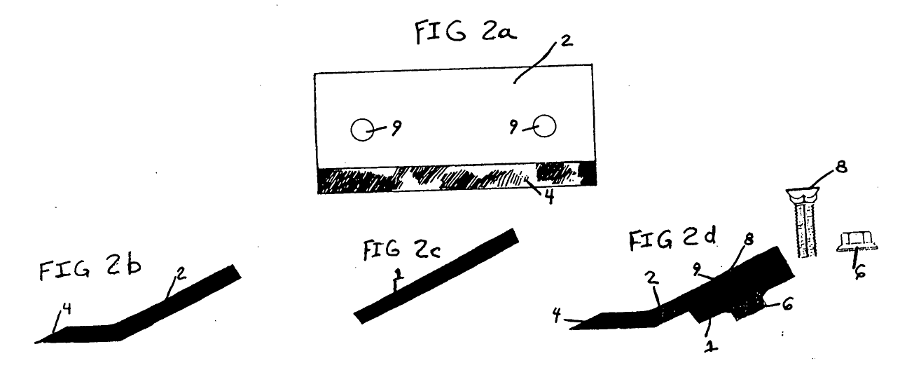

FIG. 2a shows an alternative attachment mechanism. In this mechanism, the detachable cutting edge 2 has recessed holes 9. The holes are shaped to lock the attachment mechanism head from rotating when passed through both a cutting edge and a carrier. FIG. 2b shows the profile view of a cutting edge 2. FIG. 2c shows a profile view of a carrier 1. FIG. 2d shows a profile view of a blade assembly. The bolts 8 lie flush with the surface of the cutting edge. The bolts 8 are secured with a nut 6 that can be accessed from the bottom of the carrier for removal.

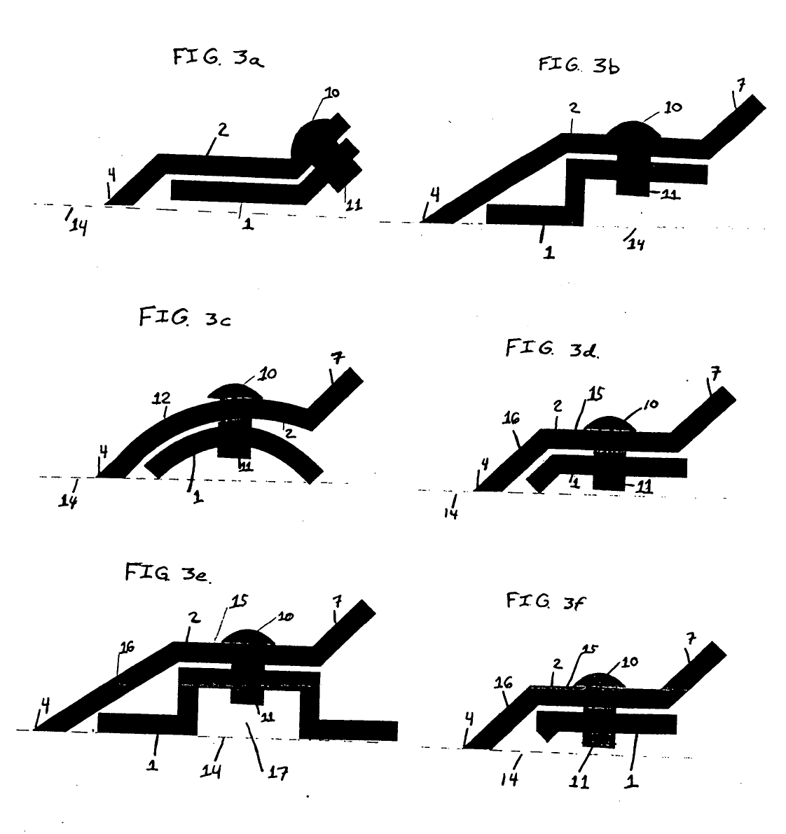

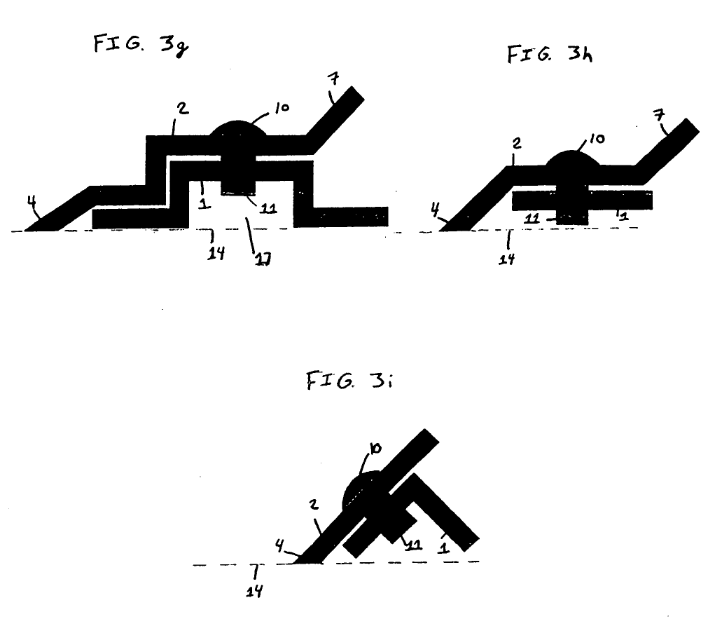

FIGS. 3.a through FIG. 3.i present various profile views of differing blade assemblies. In each assembly there is a carrier 1, detachable cutting edge 2 and an attachment mechanism 10. In each assembly the attachment mechanism is accessed at from the bottom of the carrier 11. Access to the attachment mechanism from the bottom of the carrier is an advantage of the present invention. Since the attachment mechanism can be accessed from the bottom of the carrier, it is unnecessary to remove the entire blade assembly from the drive shaft of a push lawn mower or the spindle shaft of a riding mower. It is also unnecessary to turn the lawn mower on its side, place it on ramps, hoist or jack the mower up to replace a blade. This is of particular advantage in larger riding lawn mowers.

FIGS. 3a and 3b show two different assemblies where the attachment region of the blade assembly is raised above the cutting plane 14 to protect the attachment mechanism from rocks and other foreign objects.

FIG. 3c shows a blade assembly having been curved to a sufficient radius so that the curved top face 12 of the blade assembly protects the attachment mechanism from rocks and other foreign objects while still allowing access to remove the attachment mechanism at the bottom of the assembly 11.

FIGS. 3d and 3f shows multiple blade assemblies with a removable cutting edge being bent to an angle creating multiple surfaces so that a first surface 15 of the cutting edge is parallel with the carrier for fastening, a second surface 16 of the cutting edge extends forward of the carrier 1 so that the second surface 16 of the cutting edge and front of the carrier protects the attachment mechanism 10 from rocks and other foreign objects. A third surface 7 shown in FIGS. 3d and 3f is an optional lift for use in certain mulching mowers.

FIG. 3e shows a blade assembly with a removable cutting edge being bent to an angle creating multiple surfaces so that a first surface 15 of the cutting edge is parallel with the carrier for fastening, a second surface 16 of the cutting edge extends forward of the carrier 1 so that the second surface 16 of the cutting edge and front of the carrier protects the attachment mechanism from rocks and other foreign objects. A third surface 7 is an optional lift for use in certain mulching mowers. Additionally, the carrier 1 is bent multiple times forming a track 17. The track provides additional protection for the attachment mechanism.

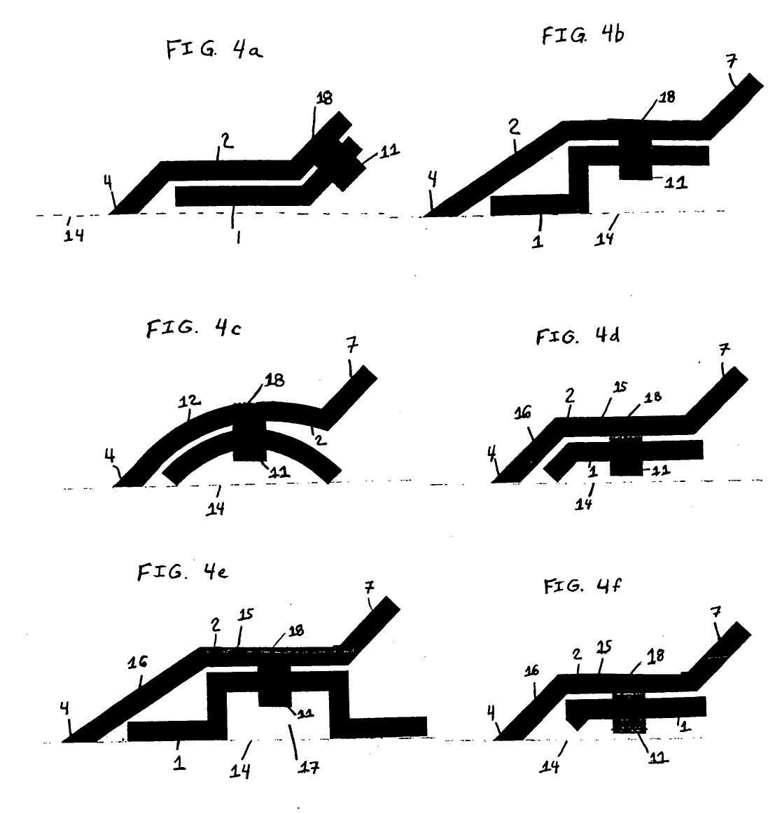

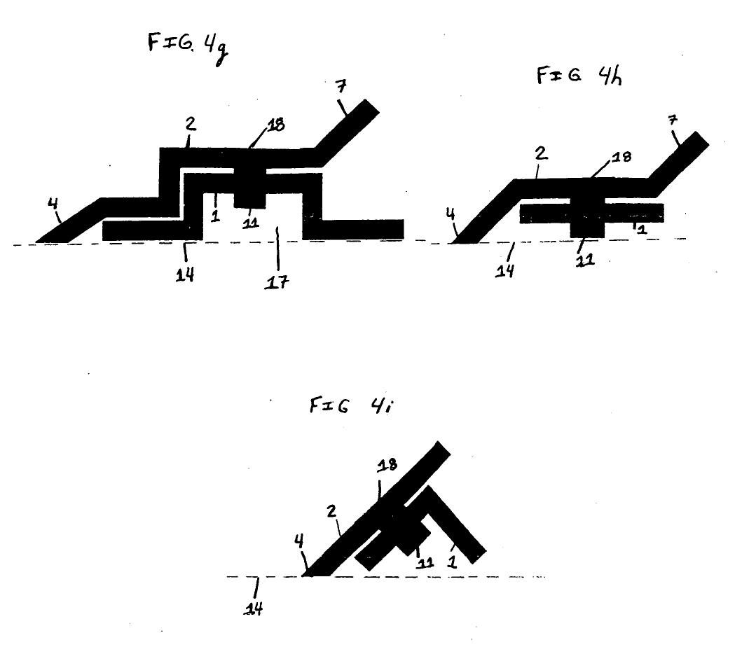

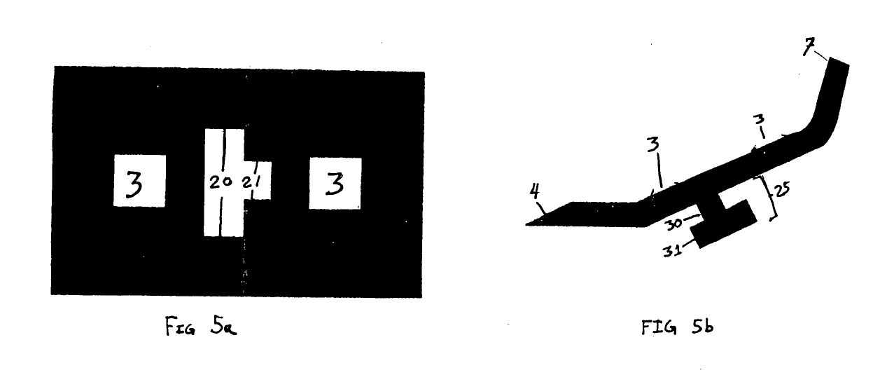

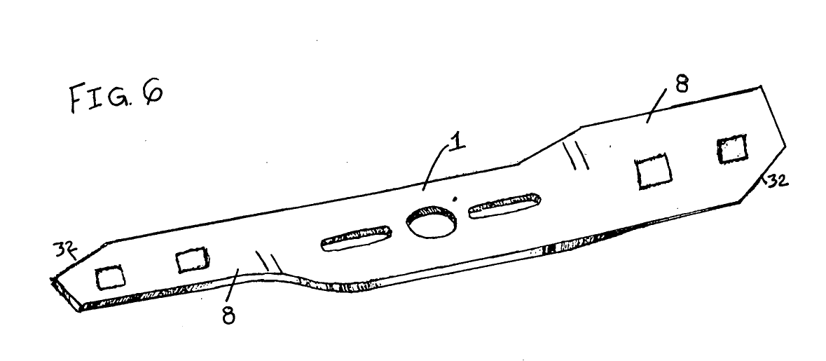

FIGS. 4a through FIG. 4i present various profile views of differing blade assemblies similar to those in FIGS. 3a through FIG. 3i. In each assembly there is a carrier 1, a detachable cutting edge 2 and an attachment mechanism. Each attachment mechanism is protected from foreign objects. Different from FIGS. 3a through 3i, the head 18 of the attachment mechanism in each assembly is recessed into the cutting edge 2. The recessing of the head of the attachment mechanism provides it additional protection.

FIG. 5a presents a top view of the end region of a carrier with a slot safety mechanism. FIG. 5b presents a side view of a detachable cutting edge with slot safety mechanism. A slot safety mechanism provides additional protection in the event bolts are sheared by a foreign object. The end region of the carrier contains shaped holes 3 for receiving bolts, and a center slot with an insertion region 20 and a holding region 21. The detachable cutting edge contains corresponding shaped holes 3 and a T insert 25. The T insert has a neck 30 and a head 31, the head being wider than the neck. In attaching the cutting edge to the carrier, the T insert is placed through the insertion region of the center slot. The cutting edge is then slid so that the T insert is in the holding region of the center slot. Once in the holding region of the center slot, the shaped holes on the carrier and the cutting edge line up so that a bolt can be placed through each pair of holes. The width of the head of the T insert is narrow enough to pass through the insertion region of the center slot, but too wide to pass through the holding region of the center slot.

FIG. 6 presents a perspective view of an example carrier. The carrier has been modified by slanting the leading edge 32 of the carrier ends 8. The slanted leading edge provides protection to the carrier by allowing a larger degree of wear to occur to the removable blades rather then on the carrier.

Advantages of the present invention include the ability to replace the cutting edge of a rotary lawn mower without removing the lawn mower blade at the motor power shaft of a push mower or at the spindle shaft of a riding mower. The present invention permits easy access to the attachment mechanism of the blade assembly from the bottom of the carrier. The present invention protects the attachment mechanism from rocks and other foreign objects.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

1. A lawn mower blade comprising:
a) a carrier with a central hole for direct connection to the drive shaft of a push lawn mower engine or the spindle shaft of a riding mower;
b) the carrier having a top, a bottom and two ends with at least one end having a hole;
c) a detachable cutting edge with at least one hole; and
d) an attachment mechanism that fastens the cutting edge directly to the top or bottom of the carrier through the hole in the cutting edge and the end hole of the carrier where the attachment mechanism is removed by access to the bottom of the carrier.

2. A lawn mower blade as in claim 1 where the carrier is shaped to protect the attachment mechanism.

3. A lawn mower blade as in claim 1 where the cutting edge is shaped to protect the attachment mechanism.

4. A lawn mower blade as in claim 1 where the carrier and cutting edge are both shaped to protect the attachment mechanism.

5. A lawn mower blade as in claim 1 where the cutting edge has a sharpened leading edge which in operation travels on a cutting plane and where the attachment mechanism is above the cutting plane.

6. A lawn mower blade comprising:
a) a carrier with a central hole for direct connection to the drive shaft of a push lawn mower engine or the spindle shaft of a riding mower;
b) the carrier having a top, a bottom and two ends with at least one end having a hole;
c) a detachable cutting edge with at least one hole;
d) an attachment mechanism that fastens the cutting edge directly to the top or bottom of the carrier through the hole in the cutting edge the end hole of the carrier; where the attachment mechanism is removed by access to the bottom of the carrier; and where the attachment mechanism is protected by the shape of the carrier.

7. A lawn mower blade comprising:
a) a carrier with a central hole for direct connection to the drive shaft of a push lawn mower engine or the spindle shaft of a riding mower;
b) the carrier having a top, a bottom and two ends with at least one end having a hole;
c) a detachable cutting edge with at least one hole; and
d) an attachment mechanism that fastens the cutting edge directly to the top or bottom of the carrier through the hole in the cutting edge the end hole of the carrier; where the attachment mechanism is removed by access to the bottom of the carrier, and where the attachment mechanism is protected by the shape of the cutting edge.

8. A lawn mower blade comprising:
a) a carrier with a central hole for direct connection to the drive shaft of a push lawn mower engine or the spindle shaft of a riding mower;
b) the carrier having a top, a bottom and two ends with at least one end having a hole;
c) a detachable cutting edge with at least one hole; and
d) an attachment mechanism that fastens the cutting edge directly to the top or bottom of the carrier through the hole in the cutting edge the end hole of the carrier; where the attachment mechanism is removed by access to the bottom of the carrier; and where the attachment mechanism is protected by the shape of the carrier and the shape of the cutting edge.

9. A lawn mower blade comprising:
a) a carrier with a central hole for direct connection to the drive shaft of a push lawn mower engine or the spindle shaft of a riding mower;
b) the carrier having a top, a bottom and two ends with at least one end having a hole;
c) a cutting mechanism with at least one hole;
d) means for mounting cutting mechanism to the top or bottom of the carrier where the means for mounting transverses the hole in the cutting mechanism and the end hole of the carrier; and
e ) where the means for mounting is removed by access to the bottom of the carrier.

10. A lawn mower blade comprising:
a) a carrier with a central hole for direct connection to the drive shaft of a push lawn mower engine or the spindle shaft of a riding mower;
b) the carrier having a top a bottom and two ends with at least one end having a hole;
c) a detachable cutting edge with at least one hole; and
d) means for mounting the detachable cutting edge directly to the top or bottom of the of the carrier where the means for mounting transverses the hole in the detachable cutting edge and the end hole of the carrier; where the means for mounting is protected by the carrier.

11. A lawn mower blade comprising:
a) a carrier with a central hole for direct connection to the drive shaft of a push lawn mower engine or the spindle shaft of a riding mower;
b) the carrier having a top, a bottom and two ends with at least one end having a hole;
c) a detachable cutting edge with at least one hole; and
d) means for mounting the detachable cutting edge directly to the top or bottom of the carrier where the means for mounting transverses the hole in the detachable cutting edge and the end hole of the carrier; where the means for mounting is protected by the detachable cutting edge.

12. A lawn mower blade comprising:
a) a carrier with a central hole for direct connection to the drive shaft of a push lawn mower engine or the spindle shaft of a riding mower;
b) the carrier having two ends with at least one end having a hole
and a slot; the slot having an insertion region and a holding region;
c) a detachable cutting edge with at least one hole and a T insert; the T insert having a neck and a head, the head being wider than the neck;
d) an attachment mechanism that fastens the cutting edge directly to the carrier; where the T insert is placed through the insertion region of the slot; where the cutting edge is then slid so that the T insert is in the holding region of the slot and a bolt is placed through the hole in the cutting edge and the end hole of the carrier; where a nut is placed on the bolt; and
e) where the nut is accessed from the bottom of the carrier.
